(19) United States
(12) Patent Application Publication
(10) Pub. No.: US 2007/0205914 A1
(43) Pub. Date: Sep. 6, 2007

(54) Remote operating apparatus and method of controlling the same

(75) Inventors: Seong Cheol Choi, Gyeonggi-do (KR); Kyung Ho Yoon, Incheon-si (KR)

Correspondence Address: BIRCH STEWART KOLASCH & BIRCH, PO BOX 747, FALLS CHURCH, VA, 22040-0747, US

(73) Assignee: Seong Cheol CHOI

(21) Appl. No.: 11/638,403

(22) Filed: Dec. 14, 2006

(30) Foreign Application Priority Data
Mar. 3, 2006 (KR) 10-2006-0020611

(51) Int. Cl. G08C 19/00; H04B 10/00

(52) U.S. Cl. 340/825.72; 398/106

(57) ABSTRACT

A remote operating apparatus is provided. A receiving unit receives an arbitrary infrared signal generated as an arbitrary key of a remote control unit is input, and converts the received infrared signal into an electric signal. A control unit reads the electric signal converted by the receiving unit. The driving is operated under control in response to a control signal of the control unit. The control unit controls an operation of the drive unit whenever reading the electric signal.

### BACKGROUND OF THE INVENTION

1. Field of the Invention

The present invention relates to a remote operating apparatus, and more particularly, to a remote operating apparatus and a method of controlling the same capable of receiving every infrared signal generated from a predetermined remote control unit, and controlling an operation of an electronic device using the received infrared signal.

Particularly, when the electronic device is a lamp, the illuminance of the lamp can be changed by the remote operating apparatus according to a received infrared signal. Also, when the electronic device is an electric fan, a rotation speed of a motor can be controlled by the remote operating apparatus in response to a received infrared signal.

2. Description of the Related Art

In order to turn on or off the related art electronic devices, for example, various kinds of lamps including an incandescent lamp and a fluorescent lamp, AC power applied to a corresponding lamp should be switched on or off.

That is, a lamp illuminating a room or an outdoor space using electricity has at least one power switch, and the lamp is turned on or off by switching on or off the AC power applied from the outside using the power switch.

The power switch is commonly placed near to a corresponding lamp or an entrance. In general, a plurality of lamps are installed in an office or a house, and those lamps are turned on and off by manipulation of power switches corresponding to the respective lamps.

To obviate inconvenience of individual manipulation, a method of controlling power on/off of the lamps with a radio remote control unit has been proposed.

However, RF (radio frequency) radio control requires a remote control unit dedicated to a corresponding lamp, and a large number of components for the circuit configuration, which undesirably increases a unit cost.

Also, as a plurality of remote control units for controlling respective electronic devices are becoming necessary, it is difficult for a user to find a remote control unit available for an electronic device that is to be controlled. If the user has lost the required remote control unit, it becomes even impossible to perform radio control on the corresponding electronic device.

Also, like the RF radio control, radio control using an infrared ray also requires a dedicated remote control unit, and in case where the corresponding remote control unit has been lost, it becomes impossible to remotely control an operation of for example, a lamp. Also, disadvantageously, such a remote control unit cannot be used for a lamp having a ballast such as a compact fluorescent light bulb or the like. This is because a peak of an infrared signal emitted from a fluorescent lamp, and peaks of an electromagnetic wave and a start voltage coming out of a ballast circuit are very high, and thus mal-functioning or breakdown of a product easily occurs.

### SUMMARY OF THE INVENTION

Accordingly, the present invention is directed to a remote operating apparatus and a method of controlling the same that substantially obviate one or more problems due to limitations and disadvantages of the related art.

An object of the present invention is to provide a remote operating apparatus and a method of controlling the same capable of detecting every infrared signal generated from a remote control unit, and controlling a predetermined electronic device according to the detected infrared signal.

Another object of the present invention is to provide a remote operating apparatus and a method of controlling the same capable of allowing control in response to every received infrared signal so that a remote control unit already existing in a house or an office can be used, and user's convenience can be improved.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a remote operating apparatus including: a receiving unit receiving an arbitrary infrared signal generated as an arbitrary key of a remote control unit is input, the receiving unit converting the received infrared signal into an electric signal; a control unit reading the electric signal converted by the receiving unit; and a drive unit operated under control in response to a control signal of the control unit. The control unit controls an operation of the drive unit whenever reading the electric signal.

In the remote operating apparatus and the method of controlling the same according to an embodiment of the present invention, since an operation of the remote operating apparatus is controlled in response to input of every infrared signal, a remote control unit already existing at home or in an office can be used, and a cost for another remote control unit can be saved.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram for describing a remote operating apparatus according to an embodiment of the present invention;

FIG. 2 is a circuit diagram for describing a remote operating apparatus according to an embodiment of the present invention;

FIG. 3 is a circuit diagram of a receiving unit according to an embodiment of the present invention;

FIG. 4 illustrates one example of a transmission format in case where an infrared signal emitted from a predetermined remote control unit is converted into an electric signal;

FIG. 5 is an exploded perspective view for describing the case where a remote operating apparatus is used for a lamp according to an embodiment of the present invention;

FIG. 6 is an assembled perspective view for describing the case where a remote operating apparatus is used for a lamp according an embodiment of the present invention; and

FIG. 7 is a flow chart of a method of controlling a remote operating apparatus according an embodiment of the present invention.

### DETAILED DESCRIPTION OF THE INVENTION

Reference will now be made in detail to the preferred embodiments of the present invention, examples of which are illustrated in the accompanying drawings.

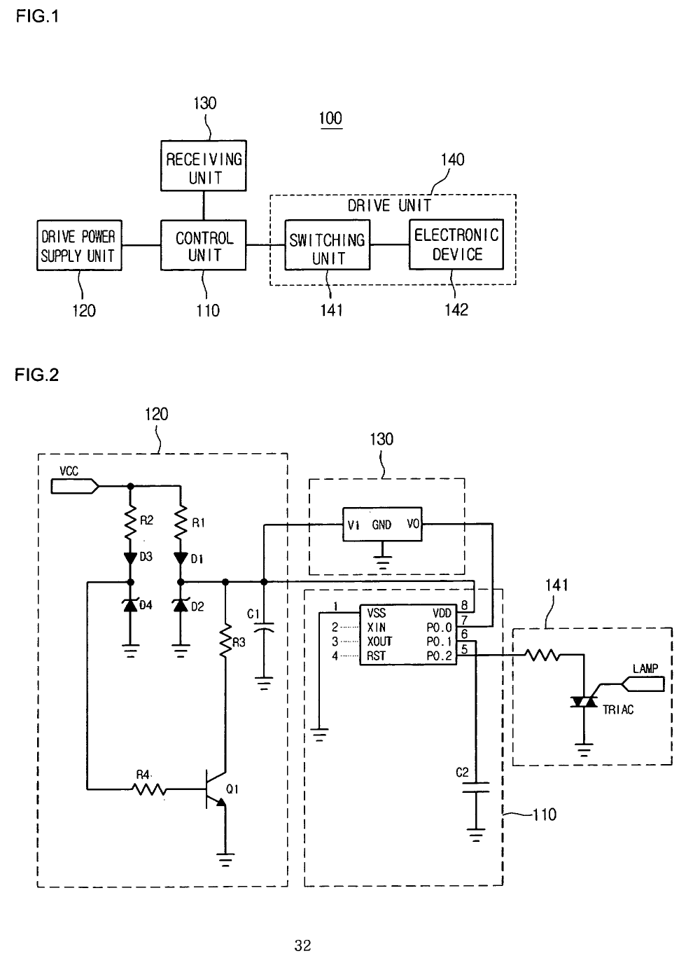

FIG. 1 is a block diagram for describing a remote operating apparatus according to an embodiment of the present invention. Referring to FIG. 1, a remote operating apparatus 100 includes a drive power supply unit 120 supplying drive power, a receiving unit 130 receiving an infrared signal generated from a predetermined remote control unit, a control unit 110 reading an electric signal converted by the receiving unit 130 and generating a predetermined control signal in response to the electric signal, and a drive unit 140 driven in response to the control signal of the control unit 110. The drive unit 140 includes a switching unit 141 and a predetermined electronic device 142 connected to the switching unit 141.

The switching unit 141 may switch a voltage level for operating the electronic device 142 in response to the control signal of the control unit 110. That is, the switching unit 141 may control the magnitude of a voltage being supplied to the electronic device 142. In detail, the receiving unit 130 converts a received infrared signal into an electric signal. The control unit 110 changes an output voltage being supplied to the drive unit 140 whenever reading the electric signal.

The receiving unit 130 receives every input infrared signal and converts the received infrared signal into an electric signal. Also, the receiving unit 130 rectifies a signal to configure the electric signal into a predetermined control format.

That is, when an infrared signal generated from the remote control unit is converted into a predetermined electric signal, the electric signal includes control signal output data, a code value for performing functions including power on/off of an electronic device, channel control, volume control, and illuminance control of an electronic device, and a control signal transmission format, a waveform format for transmitting the control signal output data.

The receiving unit 130 determines whether the converted electric signal has a predetermined transmission format, so as to filter a noise which does not include a predetermined control signal. That is, since an infrared signal emitted from a general remote control unit has a predetermined transmission format in general, the receiving unit 130 determines whether the received infrared signal has a predetermined transmission format so as to filter a noise, that is, an infrared signal which is not emitted from a predetermined remote control unit.

Of course, the control unit 110 may determine whether an electric signal has a predetermined transmission format.

The control unit 110 may read an electric signal having a predetermined transmission format by the receiving unit 130. Also, when a user manipulates a remote control unit to apply an infrared signal to the remote operating apparatus, the remote operating apparatus 100 can be operated.

That is, as the receiving unit 130 removes the noise, the control unit 110 may read an electric signal into which every infrared signal generated by the remote control unit is converted.

The control unit 110 controls an operation of the switching unit 141 in response to every electric signal transmitted from the receiving unit 130. That is, the control unit 110 controls the switching unit 141 or the drive unit 140 according to whether or not the electric signal transmitted from the receiving unit 130 is present, regardless of which format the electric signal transmitted from the receiving unit 130 has.

Accordingly, the user may control the remote operating apparatus 100 using an existing remote control unit. By controlling the remote operating apparatus 100, an operation of the electronic device 142 connected to the switching unit 141 can be controlled.

In more detail, an arbitrary remote control unit includes a plurality of keys. When any of those keys is input and thus an arbitrary infrared signal is generated, the receiving unit 130 receives the generated infrared signal and converts the infrared signal into an electric signal. Then, the control unit 110 outputs a predetermined control signal in a set sequence, corresponding to the electric signal into which the arbitrary infrared signal is converted.

The sequence is for controlling an operation of the drive unit 140, and may be a control signal with respect to a voltage output through the switching unit 141. The control unit 110 changes the magnitude of the voltage output through the switching unit 141 whenever an arbitrary electric signal is input to the control unit 110 from the receiving unit 130.

That is, a user can control the operation of the remote operating apparatus 100 by manipulating an arbitrary remote control unit prepared in a house or an office.

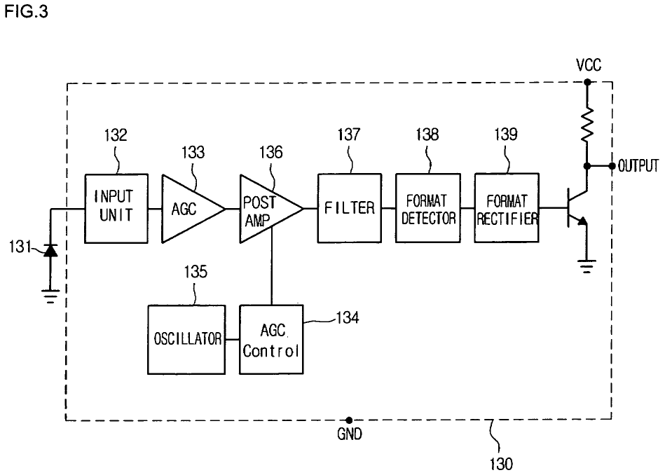

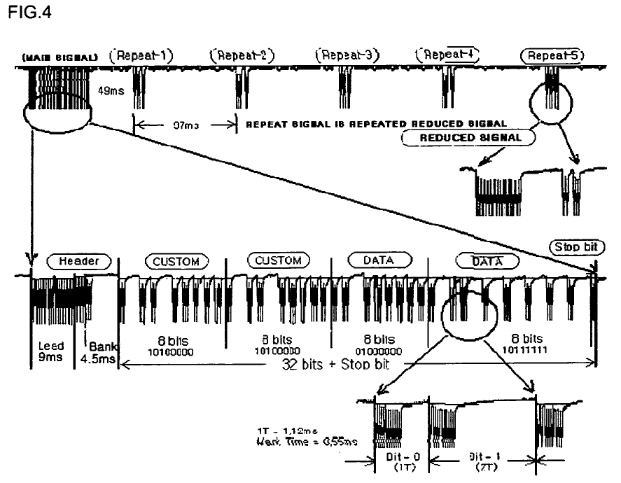

FIG. 2 is a circuit diagram for describing a remote operating apparatus according to an embodiment of the present invention, and FIG. 3 is a circuit diagram of a receiving unit according to an embodiment of the present invention. FIG. 4 illustrates one example of a transmission format in the case where an infrared signal emitted from a predetermined remote control unit is converted into an electric signal.

Referring to FIGS. 2 through 4, as described above, a remote operating apparatus according to an embodiment of the present invention includes a receiving unit 130 receiving an infrared signal from a predetermined remote control unit and converting the received infrared signal into an electric signal, a control unit 110 switching an input signal converted by the receiving unit 130 and outputting a control signal, a switching unit 141 outputting a switching signal in response to the control signal of the control unit 110 and controlling an electronic device (e.g., a lamp), and a drive power supply unit 120 supplying a drive voltage Vcc necessary for the driving of a circuit.

When a user manipulates a predetermined remote control unit, an infrared signal of a predetermined frequency is output through a drive circuit within the remote control unit. Then, the receiving unit 130 receives the infrared signal generated from the remote control unit.

Referring to FIG. 3, the receiving unit 130 includes a photo diode 131 converting a predetermined radio signal into an electric signal, an input unit 132 receiving the electric signal converted by the photo diode 131, an auto gain control circuit (AGC) 133 controlling the gain of the electric signal, a post amplifier (POST AMP) 133 amplifying the electric signal, an auto gain control circuit control unit (AGC control) 134 controlling the auto gain control circuit 133, an oscillator 135 generating a predetermined carrier wave; a filter 137 configured as a band pass filter in order to pass only a predetermined frequency band of the electric signal amplified by the amplifier 133, a format detector 138 determining whether the electric signal has a predetermined format for control-signal transmission, and a format rectifier 139 rectifying the electric signal.

The format detector 138 determines whether an electric signal into which a received infrared signal is converted has a predetermined format, and then transmits the electric signal having the predetermined format to the format rectifier 139.

An electric signal into which an infrared signal emitted from a predetermined remote control unit is converted may have the format as illustrated in FIG. 4.

A main part of the illustrated control signal transmission format has total 33-bit format of ‘Leader Custom 16 bit+Data 16 bit+stop bit’. Various control signal transmission formats may be configured according to the ‘Leader’, the time lengths of Bit 0 and Bit 1, and contents of the ‘Custom’ and the ‘Data’. For reference, an electronic device that is to be controlled is selected depending on the control signal transmission format.

An electric signal output through the format rectifier 139 is transmitted to the control unit 110.

In detail, the receiving unit 130 converts a received infrared signal into an electric signal, and sends the electric signal to P0.0 of the control unit 110. When P0.2 applies a predetermined trigger current to a gate terminal of a TRIAC, the TRIAC, a switching device, is switched to a turned-on state from an off state, thereby applying predetermined power to an electronic device, for example, a lamp. In such a manner, the lamp is turned on. When an infrared signal is generated as the user inputs a predetermined key of the remote control unit in order to control the illuminance of the lamp, the infrared signal is received by the receiving unit 130 again.

The infrared signal is converted into an electric signal by the receiving unit 130, and is sent to the P0.0 of the control unit 110. As the P0.2 applies a predetermined trigger current to a gate terminal of the TRIAC, the power is re-applied to the lamp by the TRIAC.

An illuminance level of the lamp can be controlled by the power applied by the TRIAC.

The control unit 110 can turn off the power of the lamp when the number of times the control unit 110 reads the electric signal from the receiving unit 130 reaches the predetermined number of times. The detailed description thereof will be described later.

The drive power supply unit 120 includes a plurality of resistances (R1, R2, R3 and R4), diodes (D1 and D3), Zener diodes (D2 and D4) and a capacitor (C1). Since this constitution is a generalized one, the detailed description thereof will be omitted.

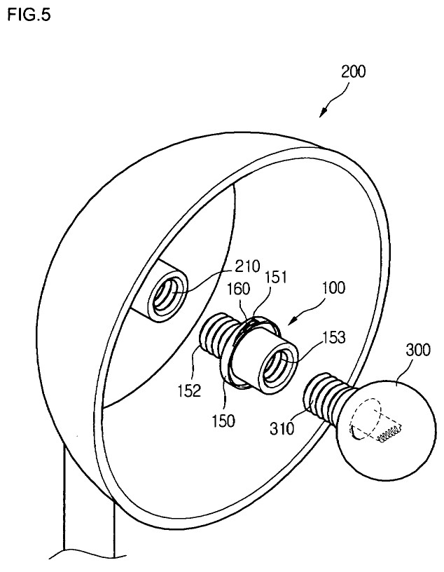

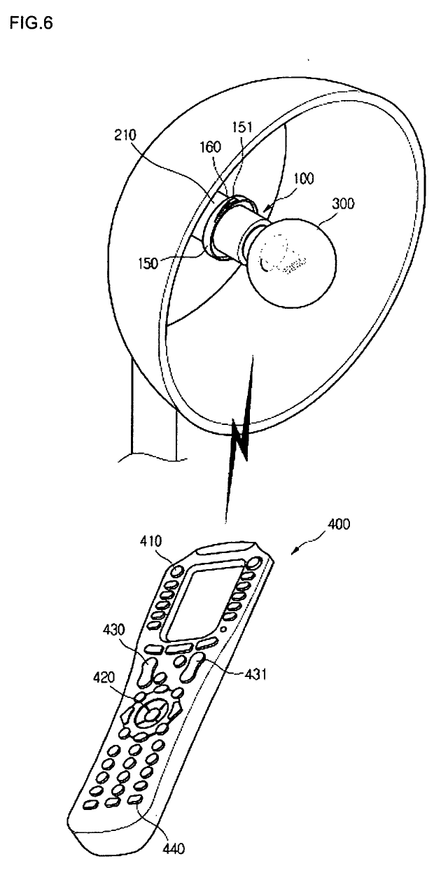

FIG. 5 is an exploded perspective view of a lamp for describing the case where a remote operating apparatus according to an embodiment of the present invention is used for the lamp. FIG. 6 is an assembled perspective view for describing the case where a remote operating apparatus according to an embodiment of the present invention is used for a lamp.

Referring to FIGS. 5 and 6, a remote operating apparatus 100 according to an embodiment of the present invention is used to control an operation of a lamp. The remote operating apparatus 100 is coupled between a bulb 300 and a lamp 200.

The remote operating unit 100 includes a socket coupling part 153 coupled to a bulb socket 310 of the bulb 300, and a connector coupling part 152 coupled to a connector 210 of the lamp 200.

In detail, the socket coupling part 153 has a predetermined screw thread so that the bulb socket 310 can be coupled thereto. Also, the connector coupling part 152 has a predetermined screw thread so as to be connected to the connector 210.

Also, the remote operating apparatus 100 includes a receive sensitivity control unit 150 allowing a user to select receive sensitivity of a control signal output from the remote control unit 400, a receive sensitivity control window 151 formed as a hole with a predetermined size on an outer circumferential surface of the receive sensitivity control unit 150, and a photo diode (131 of FIG. 3) formed inside the receive sensitivity control unit 150 and receiving an infrared signal.

The photo diode 131 is exposed to the outside through the receive sensitivity control window 151. The user rotates the receive sensitivity control unit 150, thereby setting an extent to which the photo diode 131 is exposed by the receive sensitivity control window 151.

The receive sensitivity control unit 150 is formed of a material blocking an infrared signal.

For example, when the exposure extent of the photo diode 131 through the receive sensitivity control window 151 is set to be very small, the photo diode 131 can receive an infrared signal only when the remote control unit 400 is aimed squarely at the receive sensitivity control window 151.

In contrast, when the user sets the exposure extent of the photo diode 131 to be great, the photo diode 131 can receive an infrared signal even if the remote control unit 400 is not squarely aimed at the receive sensitivity control window 151.

The exposure extent of the photo diode through the receive sensitivity control window 151 may be varied according to locations of the remote operating apparatus 100 and the lamp 200.

For example, if the remote control unit 400 is a TV remote control unit and the remote operating apparatus 100 is placed very close to a TV, the extent to which the photo diode 131 is exposed through the receive sensitivity control window 151 may be set to be very small. In this case, since the remote operating apparatus 100 is operated only when the remote control unit 400 is accurately aimed at the photo diode 131, the case where the TV is operated by the manipulation of the remote control unit 400 can be reduced.

Also, the remote control unit 400 may include a power button 410, a channel up/down button 430, a volume up/down button 431, a confirm button 420, and an option setting button 440, etc. Even when the TV is in a turned-on state, the user inputs the confirm button 420 or the option setting button 440 to operate the remote operating apparatus 100.

This is because in most cases, input of the confirm button 420 or the option setting button 440 can be made when a predetermined menu input button (not shown) provided in the remote control unit 400 has been pressed, that is, in a menu input mode.

The receive sensitivity control unit 150 includes therein a circuit board (not shown) including a control unit 110, a drive power supply unit 120, a receiving unit 130 and a switching unit 141 (illustrated in FIG. 1). Power being applied to the drive power supply unit 120 is supplied through the connector 210 coupled to the connector coupling part 152.

The voltage output by the switching unit 141 is applied to the bulb 300 through the socket coupling part 153 and the bulb socket 310. Particularly, the illuminance of light emitted by the bulb 300 varies according to the magnitude of the voltage output by the switching unit 141.

By the configuration described above, the photo diode (131 of FIG. 3) can receive every infrared signal output as an arbitrary key of an arbitrary remote control unit is input, so that the remote operating apparatus 100 and a predetermined electronic device connected to the remote operating apparatus 100 can be controlled.

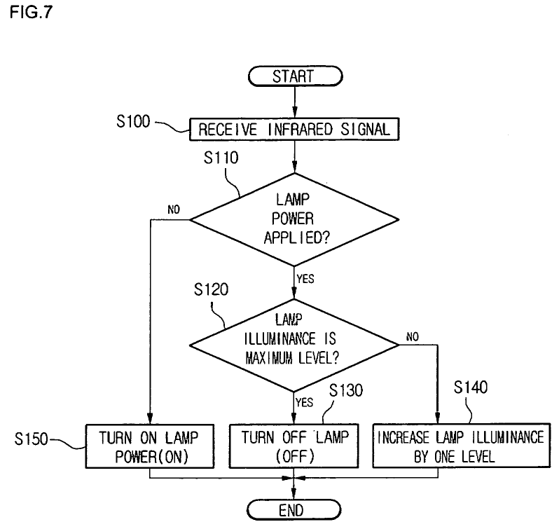

FIG. 7 is a flow chart of a method of controlling a remote operating apparatus according to an embodiment of the present invention. For reference, in FIG. 7, the case where the remote operating apparatus is used for a lamp is taken as an example.

The receiving unit 130 receives every infrared signal emitted as an arbitrary key of an arbitrary remote control unit is input (S100). Then, the receiving unit 130 converts the received infrared signal into a predetermined electric signal.

The control unit 110 reads the electric signal converted by the receiving unit 130, and determines whether power of a lamp connected to the switching unit 141 is turned on (S110)

When the determination result shows that the lamp power is turned on, the control unit 110 determines whether the illuminance of the lamp has reached a maximum level by a voltage output from the switching unit 141 (S120). To this end, the control unit 110 has a preset voltage table (or an illuminance table) of the lamp including predetermined steps, and the control unit 110 counts the number of times the electric signal is input from the receiving unit 130. Also, the control unit 110 controls the magnitude of the voltage output through the switching unit 141 according to the number of times the electric signal is input.

If the illuminance of the lamp connected to the switching unit 141 has already reached the maximum level, the control unit 110 sets the magnitude of the voltage output through the switching unit 141 to ‘0’, thereby turning off the lamp power (S130).

If the illuminance of the lamp has not reached the preset maximum level at the time of input of the electric signal to the control unit 110, the control unit 110 further increases the voltage level output through the switching unit 141 (S140). As the control unit 110 increases the voltage level output through the switching unit 141, the illuminance of the lamp is increased.

If the lamp power is in a turned-off state when the electric signal is input to the control unit 110, the control unit 110 allows a predetermined voltage to be output through the switching unit 141 to turn on the lamp power (S150). Here, the voltage level output through the switching unit 141 may be the lowest level in the preset illuminance table.

Even though an embodiment of the present invention is applied to the lamp in the description above, the embodiment of the present invention may be applied in the case where a predetermined motor is coupled to the switching unit 141. In this case, an RPM (revolution per minute) of the motor can be controlled by controlling a voltage output through the switching unit 141, and this is pulse width modulation by the control unit 110 (i.e., a micro-control unit).

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A remote operating apparatus comprising:
a receiving unit receiving an arbitrary infrared signal generated as an arbitrary key of a remote control unit is input, the receiving unit converting the received infrared signal into an electric signal;
a control unit reading the electric signal converted by the receiving unit; and
a drive unit operated under control in response to a control signal of the control unit,
wherein the control unit controls an operation of the drive unit whenever reading the electric signal.

2. The apparatus according to claim 1, wherein the control unit changes a magnitude of a voltage supplied to the drive unit, whenever reading the electric signal.

3. The apparatus according to claim 1, wherein the drive unit comprises a switching unit connected to a predetermined electronic device,
wherein the control unit changes a magnitude of an output voltage supplied to the electronic device by controlling the switching unit whenever reading the electric signal.

4. The apparatus according to claim 3, wherein the switching unit is connected to a predetermined bulb socket and a bulb,
wherein the control unit controls on/off of the bulb and illuminance of the bulb by controlling the magnitude of the voltage output through the switching unit.

5. The apparatus according to claim 1, wherein the control unit gradually increases a magnitude of a voltage output through the drive unit as the number of times the electric signal is input increases, or controls the magnitude of the voltage output through the drive unit to be zero.

6. The apparatus according to claim 1, wherein the receiving unit comprises a format detector determining whether the converted electric signal has a predetermined control format.

7. The apparatus according to claim 6, wherein when the converted electric signal has the predetermined control format, the receiving unit transmits the electric signal to the control unit.

8. A remote operating apparatus comprising:
a receiving unit receiving every infrared signal generated as an arbitrary key of a remote control unit is input; and
a control unit generating the same sequence whenever an electric signal is transmitted from the receiving unit.

9. The apparatus according to claim 8, wherein the sequence is a control signal with respect to a magnitude of an output voltage,
wherein the control unit generates a control signal with respect to a magnitude of the output voltage, whenever an electric signal is transmitted from the receiving unit.

10. A remote operating apparatus for controlling an operation of a lamp using an infrared signal emitted from a remote control unit, the apparatus comprising:
a socket coupling part to which a predetermined bulb socket is coupled;
a connector coupling part coupled to a connector formed at the lamp;
a receive sensitivity control unit formed at a lower side of the socket coupling part and controlling a sensitivity of an infrared signal emitted from the remote control unit; and
a circuit board provided inside the receive sensitivity control unit, and comprising a receiving unit receiving an infrared signal emitted from the remote control unit and a control unit reading an electric signal converted by the receiving unit and emitting a predetermined control signal,
wherein the receiving unit is exposed through a hole formed with a predetermined size at the receive sensitivity control unit, and the receiving unit receives an arbitrary infrared signal emitted from the remote control unit.

11. The apparatus according to claim 10, wherein the control unit is electrically connected to a predetermined drive unit, and controls an operation of the drive unit whenever an electric signal is input from the receiving unit.

12. The apparatus according to claim 10, wherein the circuit board further comprises a switching unit connected to a predetermined electronic device,
wherein the switching unit switches a magnitude of an output voltage supplied to the electronic device in response to a control signal of the control unit.

13. The apparatus according to claim 12, wherein the receiving unit comprises a photo diode receiving an arbitrary infrared signal and converting the received infrared signal into an electric signal,
wherein the control unit changes a magnitude of a voltage output through the switching unit according to the number of times the electric signal is input.

14. The apparatus according to claim 11, wherein the receive sensitivity control unit comprises a receive sensitivity control window formed as a hole with a predetermined size,
wherein the photo diode is exposed through the receive sensitivity control window to receive an infrared signal.

15. The apparatus according to claim 14, wherein a receive sensitivity of an infrared signal emitted from the remote control unit is changed according to an extent to which the photo diode is exposed through the receive sensitivity control window.

16. A method of controlling a remote operating apparatus, the method comprising:
receiving an arbitrary infrared signal from an arbitrary remote control unit;
converting the received infrared signal into an electric signal;
inputting the electric signal to a predetermined control unit;
changing, at the control unit, a magnitude of an output voltage according to the number of times the electric signal is input; and
outputting a voltage set by the control unit through a predetermined switching unit.

17. The method according to claim 16, wherein the changing of the magnitude of the output voltage at the control unit comprises:
counting, at the control unit, the number of times the electric signal is input; and
changing the magnitude of the voltage output through the switching unit according to the counted number of times.

18. The method according to claim 16, wherein the changing of the magnitude of the output voltage at the control unit comprises gradually increasing the magnitude of the voltage as the number of times the electric signal is input is increased.

19. The method according to claim 16, wherein the inputting of the electric signal to the control unit comprises inputting the electric signal to the control unit when the electric signal converted by the receiving unit has a transmission format including a predetermined control signal.
